(19) United States
(12) Patent Application Publication
(10) Pub. No.: US 2004/0168050 A1
(43) Pub. Date: Aug. 26, 2004

(54) System and method for analyzing encrypted packet data

(76) Inventors: Stephane Desrochers, Blainville (CA); Said Soulhi, Saint Laurent (CA)

Correspondence Address: SANDRA BEAUCHESNE, Ericsson Canada Inc., Patent Department (LMC/M/P), 8400 Decarie Blvd., Town Mount Royal, QC, H4P 2N2, CA

(21) Appl. No.: 10/370,658

(22) Filed: Feb. 24, 2003

(51) Int. Cl. H04L 9/00

(52) U.S. Cl. 713/153

(57) ABSTRACT

A method for analyzing a traffic of encrypted packet data sent over a Packet Core Network (PCN) and a traffic analysis device are provided. The method utilizes a traffic analysis device for listening to the traffic of encrypted packet data. The method further authenticates the traffic analysis device with at least one packet data node of the PCN, and sends a code from the at least one packet data node to the traffic analysis device for allowing decryption of the encrypted packet data at the traffic analysis device. The traffic analysis device analyzes the decrypted packet data. Afterwards, the method utilizes the traffic analysis device for separating instrumentation and a packet data node function for at least one packet data node.

### BACKGROUND OF THE INVENTION

1. Field of the Invention

The invention relates to analysis of encrypted packet data in a packet data network.

2. Description of the Related Art

100021 Nowadays, with the introduction of Mobile IP and Simple IP services such as VoIP (Voice over IP) or Packet Data Calls in a packet data network such as a Code Division Multiple Access 2000 (CDMA2000) network, the Quality of Service (QoS) becomes determinant issues for end-users and for network/service providers. These issues are addressed to network operators and service providers, since they are the ones that can increase the QoS of their offered services. Therefore, it could be interesting for service providers to analyze traffic in the packet data network and to return results regarding the QoS of services offered. For doing so, it is possible to use a passive measurement tool for analyzing the traffic between packet data nodes in a packet data network.

The passive measurement tool can be connected at various high aggregation points in the packet core network. For instance in CDMA2000, the passive measurement tool could be connected aside to the PDSNs to capture Simple IP and Mobile IP end-users traffic.

Reference is now made to FIG. 1, which illustrates a packet data network 100 such as a prior art Code Division Multiple Access 2000 (CDMA2000) network. The packet data network 100 comprises a Radio Access Network (RAN) 104 for receiving and sending data to a terminal 102, a Packet Data Serving Node (PDSN) 106, which is an access router for interfacing the RAN 104 and a Home Agent (HA) 108 in the packet data network 100. The HA 108 handles mobility capabilities for the terminal 102. Alternatively, in a special case such as when an Authentication, Authorization and Accounting (AAA) server is not provided, the PDSN 106 may support authentication mechanisms and a configuration option to allow the terminal 102 to receive services. The description of the RAN 104, the PDSN 106, and the HA 108 is also applied respectively to nodes to RAN 114, PDSN 112, and HA 110. However, the RAN 114 receives and sends data to an end-user using a terminal 116. FIG. 1 defines an end-to-end connection 118 between the terminal 102 and the terminal 116. Furthermore, in FIG. 1, other links (120, 130, 140, 150, 160, and 170) are defined between packet data nodes. In the packet data network 100, packet data transmitted on the physical links between packet data nodes can be encrypted using a protocol such as IP Security (IPsec) or 128-bits Secure Sockets Layer (SSL) encryption, which are included herewith by reference. Since packet data transmitted on physical links between the packet data nodes of FIG. 1 can be encrypted, it is not possible to perform detailed measurements on these links without an additional mechanism. Thus, it is also not possible for instance to analyze QoS on these links.

However, with Lawful Interception authorization it is possible for authorized Organizations to listen to traffic composed of encrypted packet data and non-encrypted packet data. Lawful Interception is described in an interim standard J-STD-025 from ANSI-41, which is included herewith by reference. This Interim Standard defines the interfaces between a Telecommunication Service Provider (TSP) and a Law Enforcement Agency (LEA) to assist the LEA in conducting lawfully authorized electronic surveillance.

Hence, in a way to perform measurements, it can be possible to passively listen to the traffic of encrypted packet data on the physical link 150 or on any other physical link of FIG. 1 by using a passive measurement tool that would receive a duplication of the traffic of non-encrypted previously decrypted at the packet data node, which is the PDSN 112 in this case. Alternatively, a method based on the Lawful Interception can be based on the sending to the passive measurement tool of a duplicate of packet data before they get encrypted or a duplicate of encrypted packet data that have been decrypted at the packet data node. This is defined as instrumentation performed by the packet data node.

Although, a method such as the one above-described needs instrumentation to be performed from the packet data node where the passive measurement tool is passively listening. Nowadays, the instrumentation is not scalable and causes an overload of packet data in the packet data node where the packet data are duplicated and passively listened. More particularly, this result in a degradation of service in a packet data network and thus it is not possible to perform measurements on the traffic of encrypted packet data without causing degradation in the packet data network. Therefore, there is a need to allow the analysis of the traffic of encrypted packet data in a packet data network. The invention provides a solution to this problem.

### SUMMARY OF THE INVENTION

It is therefore one broad object of this invention to provide a method for analyzing a traffic of encrypted packet data sent over a Packet Core Network (PCN), the method comprising steps of:

listening to the traffic of encrypted packet data at a traffic analysis device;

authenticating the traffic analysis device with at least one packet data node of the PCN, the at least one packet data node being capable of decrypting the encrypted packet data;

sending a code from the at least one packet data node to the traffic analysis device;

storing the received code at the traffic analysis device;

decrypting at the traffic analysis device the encrypted packet data using the stored code; and

analyzing the decrypted packet data.

It is therefore another broad object of his invention to provide a traffic analysis device for analyzing a traffic of encrypted packet data sent over a PCN, the traffic analysis device being capable of:

listening to the traffic of encrypted packet data;

receiving a code from at least one packet data node from the PCN;

storing the received code;

decrypting the encrypted packet data using the stored code; and

analyzing the decrypted packet data.

### BRIEF DESCRIPTION OF THE DRAWINGS

100101 For a more detailed understanding of the invention, for further objects and advantages thereof, reference can now be made to the following description, taken in conjunction with the accompanying drawings, in which:

FIG. 1 is illustrating a prior art Code Division Multiple Access 2000 (CDMA2000) network; and

FIG. 2 is illustrating a CDMA2000 Packet Core Network (PCN) in accordance with the invention.

### DETAILED DESCRIPTION OF THE PREFERRED EMBODIMENTS

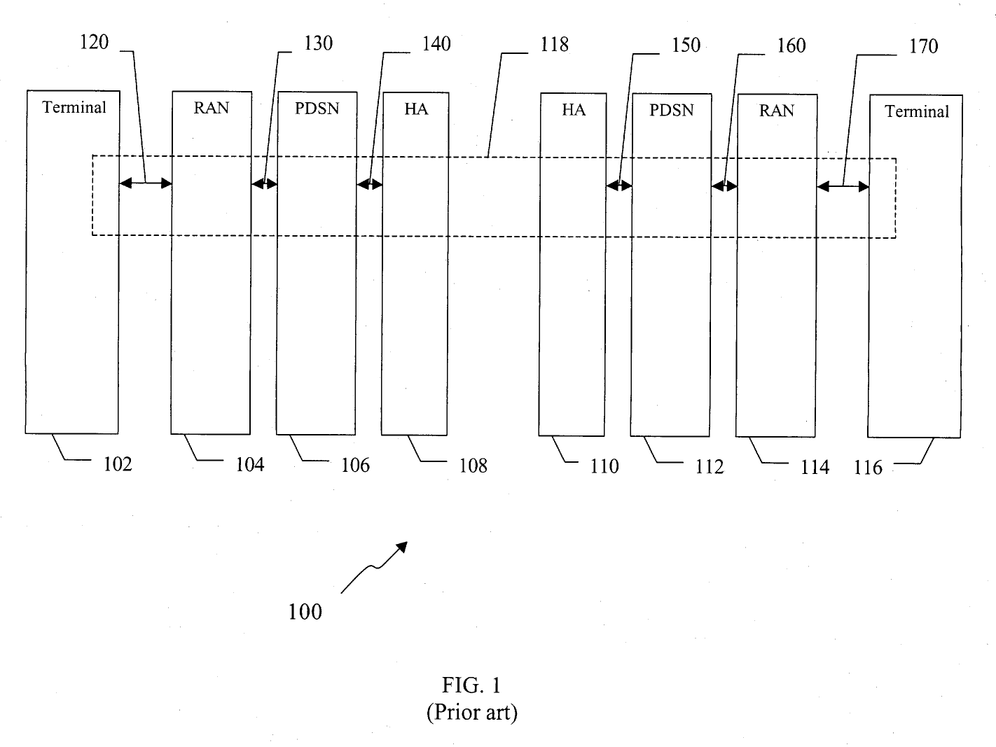

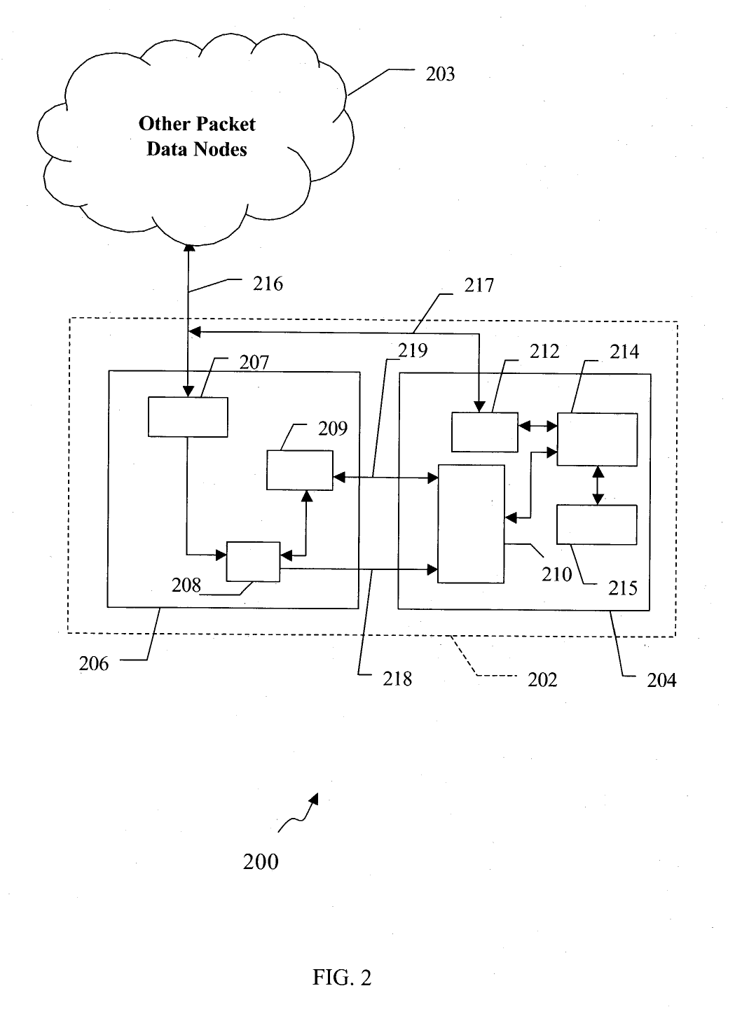

100111 Reference is now made to FIG. 2, which illustrates a CDMA2000 Packet Core Network (PCN) 200 in accordance with the invention and back concurrently to FIG. 1, which illustrates a packet data network 100 such as a prior art Code Division Multiple Access 2000 (CDMA2000) network. The PCN 200 comprises an instrumented Packet Data Serving Node (PDSN) 202 and other packet data nodes 203 such as the ones described in FIG. 1. The instrumented PDSN 202 is the result of a collocation of a PDSN 206 and a traffic analysis device 204. The application of the traffic analysis device 204 is not only limited to a PDSN such as the PDSN 206, but it may be connected to any packet data node that performs encryption and that supports an instrumentation connection protocol. In FIG. 2, the PDSN 206 is only used as an example and for that reason other nodes could have been used instead of the PDSN 206. For example, the traffic analysis device 204 can be utilized in the network of FIG. 1 and one of the other nodes could be a Home Agent (HA) 110 or 108. The traffic analysis device could thus be applicable between a PDSN and a BSC (links 130 and 160) and a PDSN and a HA (links 140 and 150) in the CDMA2000 network 100.

Furthermore, even though the usage of the traffic analysis device 204 is described for a CDMA2000 network, it can be appreciated that the traffic analysis device 204 is not limited to the CDMA2000 network. As an example, the traffic analysis device 204 can also be utilized in other packet data networks defined as a third generation 3G/Universal Mobile Telecommunications System (3G/UMTS) (e.g. a Wideband Code Division Multiple Access (WCDMA) network) or defined as any packet data network having nodes that encrypt and decrypt packet data.

The PDSN 206 is connected with the other packet data nodes 203 of the PCN 202 via a physical link 216 on which encrypted data is sent. The PDSN 206 comprises a packet data receiver 207 for receiving the traffic from other packet data nodes 203 of the PCN 200, a memory 208 for storing keys, and an authentication module 209 for authenticating the traffic analysis device 204.

The traffic analysis device 204 comprises a key receiver 210 for receiving and storing keys received from the PDSN 206 or from other packet data nodes 203 of the PCN 200, a traffic listener 212 for listening to the traffic of encrypted packet data, a processor 214 for decrypting the encrypted packet data, and an analyzer 215 for analyzing the traffic of encrypted packet data and for further storing the results of the analysis. The decrypted packet data can alternatively be sent to an authorized system that belongs for example to a Lawful Enforcement Agency (LEA) such as the Police or a Government Agency. In general, the traffic analysis device 204 may listen to the traffic of encrypted packet data at any packet data nodes that performs traffic aggregation and to packet data nodes that perform encryption of packet data. The traffic analysis device 204 works only if it receives encrypted packet data from a packet data node such as the PDSN 206 that can encrypt sent packet and decrypt packet data because the necessary keys for decrypting encrypted data has to be known by the packet data node.

Alternatively, more than one traffic analysis device 204 can be used for listening to the traffic received at one packet data node and this for different types of analysis such as Quality of Service (QoS). It is also possible for the traffic analysis device 204 to listen to the traffic received at and sent from more than one packet data node.

In FIG. 2, the traffic analysis device 204 listens to the traffic of encrypted packet data from the physical link 216 via a physical link 217. Prior to be able to be connected to the PDSN 206, the traffic analysis device 204 needs to be authenticated by the PDSN 206. For doing so, the PDSN 206 authenticates the traffic analysis device 204 via a physical link 219 between the authentication module 209 and the key receiver 210 and allows establishment of a secured link with the traffic analysis device 204. The authentication can be based for example on a general certificate of authorization, which can be stored in the authentication module 209 and/or based on defined protocols and/or a method such as a challenge authorization.

In FIG. 2, the traffic analysis device 204 is connected via a secured link 218 to the PDSN 206. The secured link 218 can be a connection using an encrypting protocol such as IP Security (IPsec) or 128-bits Secure Sockets Layer (SSL) encryption, which is used to authenticate the traffic analysis device 204 by the PDSN 206. Following the authentication, the secured link 218 allows the sending of keys from the PDSN 206 to the traffic analysis device 204. The sending of keys may be based on a timer or as required by the PDSN 206. Alternatively, keys may be exchanged based on a connection basis. For instance, if the PDSN 206 has simultaneously a number of connections on which different streams of packet data such as multimedia or Voice Over IP (VoIP) are transmitted from and to the PCN 200, an equivalent number of keys may be required for decrypting the encrypted packet data.

The format of the keys is described as being a code that allows the packet data node, such as the PDSN 206 in the present example, to decrypt incoming traffic and to encrypt outgoing traffic. An exchange of keys in the packet data network 100 such as the one described in FIG. 1 is normally done between two packet data nodes for opening a tunnel where symmetric keys are exchanged.

In particular, the traffic analysis device 204 allows separating instrumentation from the packet core function of the PDSN 206 and therefore no degradation of service occurs in the PDSN 206. Since the traffic does not need to be duplicated by the PDSN 206, the analysis is done without causing any degradation of performance in the PCN 200. Thus, the traffic analysis device 204 can provide performance indicators that can be used in for many applications such as Web browsing (time required for downloading a web page), Web page transfer delay, E-mail, Multimedia Messaging Service (MMS) and File Transfer Protocol (FTP). The performance indicators can also be used for protocols such as Transmission Control Protocol (TCP) or User Datagram Protocol (UDP).

It should be clear for those skilled in the art of the invention that the invention is not limited to the examples described before, and that many other possibilities are also encompassed by the present invention. It should also be understood that FIG. 1 and FIG. 2 each depict a simplified network, and that many other nodes have been omitted for clarity reasons only.

Although several preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for analyzing a traffic of encrypted packet data sent over a Packet Core Network (PCN), the method comprising steps of:
listening to the traffic of encrypted packet data at a traffic analysis device;
authenticating the traffic analysis device with at least one packet data node of the PCN, the at least one packet data node being capable of decrypting the encrypted packet data;
sending a code from the at least one packet data node to the traffic analysis device;
storing the received code at the traffic analysis device;
decrypting at the traffic analysis device the encrypted packet data using the stored code; and
analyzing the decrypted packet data.

2. The method of claim 1, wherein the step of authenticating further includes a step of connecting the traffic analysis device to the at least one packet data node via a secured link.

3. The method of claim 1, wherein the step of sending further includes a step of receiving the code at a key receiver of the traffic analysis device.

4. The method of claim 1, wherein the step of storing the received code at the traffic analysis device further includes a step of transmitting the code to a processor of the traffic analysis device.

5. The method of claim 1, wherein the step of analyzing further includes a step of:
analyzing the decrypted data at an analyzer of the traffic analysis device; and
storing the results of the analysis in the analyzer of the traffic analysis device.

6. A traffic analysis device for analyzing a traffic of encrypted packet data sent over a Packet Core Network (PCN), the traffic analysis device being capable of:
listening to the traffic of encrypted packet data sent to at least one packet data node of the PCN, the at least one packet data node being capable of decrypting the encrypted packet data;
receiving a code from the at least one packet data node;
storing the received code;
decrypting the encrypted packet data using the stored code; and
analyzing the decrypted packet data.

7. The traffic analysis device of claim 6, wherein the traffic analysis device comprises a key receiver for storing the received code.

8. The traffic analysis device of claim 6, wherein the traffic analysis device comprises a processor that uses the received code from the at least one packet data node for decrypting the encrypted packet data.

9. The traffic analysis device of claim 6, wherein the traffic analysis device comprises an analyzer for analyzing the decrypted packet data.

10. The traffic analysis device of claim 6, wherein the traffic analysis device further comprises:
a means for separating instrumentation and a packet data node function for the at least one packet data node.
